(19) United States
(12) Patent Application Publication
(10) Pub. No.: US 2022/0101287 A1
(43) Pub. Date: Mar. 31, 2022

(54) SYSTEM AND METHOD OF MANAGING ACCESS TO TIME-RESTRICTED CONTENT

(71) Applicant: Motorsport Network, Miami, FL (US)

(72) Inventor: Fabian Hust, Munich (DE)

(21) Appl. No.: 17/449,301

(22) Filed: Sep. 29, 2021

Related U.S. Application Data
(60) Provisional application No. 63/085,170, filed on Sep. 30, 2020.

(51) Int. Cl. G06Q 20/12; G06F 16/955; G06F 21/62

(52) U.S. Cl. CPC G06Q 20/127; G06F 21/629; G06F 16/9566

(57) ABSTRACT

A system and corresponding method of providing access to electronic media content by associating a content access time period with the electronic media content, providing a uniform resource locator (URL) to the content at a publication time, receiving a content access request from at least one content requesting entity, determining a type of requesting entity of the at least one content requesting entity, providing access to the content via the URL, based on the determining of the type of requesting entity, to the at least one content requesting entity from the publication time until an expiration of the content access time period, and providing a subscription query, based on reaching the expiration of the content access time period, to the at least one content requesting entity.

### CROSS-REFERENCE TO RELATED APPLICATION

This application claims the benefit of U.S. Provisional Application Ser. No. 63/085,170 filed Sep. 30, 2020. The disclosure of the application listed above is incorporated herein by reference in its entirety.

### BACKGROUND

Conventional media publication systems provide electronic media content to requesting users via wide area networks or the internet and require each individual user to be identified to limit access to content to registered users, (for example, a “paywall model”), or to track if media publications want to limit the user's access to content after a predetermined content consumption volume, (for example, a “metered model”). Conventional media publication sites limit content requestors to a particular number of free articles, pages, or the like, after which the user is required to pay a fee or at least to register to access content thereafter via login. Whereas paywall models can be easily protected via server authentication methods, metered model systems typically rely upon the use of cookies or similar techniques to identify content requestors that have consumed an allotted number or amount of “free” content items. However, these conventional techniques can often be bypassed or limited in efficacy by a knowledgeable user that navigates around inherent deficiencies of the metered model system, by changing or replacing requestor devices to continue to access the media or changing time codes for accessing time-metered content.

There exists a need for providing electronic media content to a plurality of content requestors, both individual users, search engine web-crawlers and social media platforms, where access to the requested content cannot be manipulated by the content requestor, but content being made accessible in a fair and equitable manner to all requestors regardless of location or access device parameters.

### BRIEF SUMMARY

It should be appreciated that this Summary is provided to introduce a selection of concepts in a simplified form that are further described below in the Detailed Description. This Summary is not intended to be used to limit the scope of the claimed subject matter.

Embodiments disclosed herein disclose systems and methods for providing time-limited access to content. For example, content such as text, images, audio, video, or combinations thereof may be provided without charge or with access requirements to one or more content requesting users or content requesting entities. After an initial access period of time, the time-limited content may be available to a content requestor only upon payment or when a user meets a particular access requirement condition, such as subscribing to a membership platform that provides the content or an affiliate site, performing a task or accessing other content.

In one embodiment disclosed herein, a method of providing access to electronic media content, the method includes associating a content access time period with the electronic media content, providing a uniform resource locator (URL) to the content at a publication time, receiving a content access request from at least one content requesting entity, determining a type of requesting entity of the at least one content requesting entity, providing access to the content via the URL, based on the determining of the type of requesting entity, to the at least one content requesting entity from the publication time until an expiration of the content access time period, and providing a subscription query, based on reaching the expiration of the content access time period, to the at least one content requesting entity.

In another embodiment disclosed herein, a method of providing access to electronic media content, the method includes associating a content access time period with the electronic media content, providing a uniform resource locator (URL) to the content at a publication time, receiving a content access request from at least one content requesting entity, determining a type of requesting entity of the at least one content requesting entity, providing access to the content via the URL, based on the determining of the type of requesting entity, to the at least one content requesting entity from the publication time until an expiration of the content access time period, providing continued access to the content via the URL after the expiration of the content access time period to the at least one content requesting entity until a second expiration of a supplemental content access time period, providing a subscription query, based on reaching the second expiration of the supplemental content access time period, to the at least one content requesting entity.

In another embodiment disclosed herein, a content access management system includes a memory configured to store processor instructions configured to provide access to electronic media content for a content requesting entity, a processor, in communication with the memory, configured to execute the processor instructions, a storage device, in communication with the processor, configured to store and retrieve the electronic media content, and a media server, in communication with the processor and the storage device. The media server being configured to associate a content access time period with the electronic media content, to provide a uniform resource locator (URL) to the content at a publication time, to receive a content access request from at least one content requesting entity, to determine a type of requesting entity of the at least one content requesting entity, to provide access to the content via the URL, based on the determining of the type of requesting entity, to the at least one content requesting entity from the publication time until an expiration time of the content access time period, and to provide a subscription query, based on reaching the expiration time of the content access time period, to the at least one content requesting entity.

### BRIEF DESCRIPTION OF THE SEVERAL VIEWS OF THE DRAWINGS

The embodiments will be better understood from the following detailed description with reference to the drawings, which are not necessarily drawing to scale and in which:

FIG. 1 illustrates a bar graph of two groups of different types of media content with respect to a publication time, an expiration time and a supplemental expiration time;

FIG. 2 illustrates a schematic diagram of a system including a content management system configured to provide content to user devices;

FIG. 3 illustrates a logical flowchart of a method of providing grouped and categorized content to a content requestor;

FIG. 4 illustrates a logical flowchart of a method of providing a user interface on a content requestor device;

FIG. 5 illustrates a logical flowchart of a method of receiving a query for content after an expiration of a content access period of time;

FIGS. 6A and 6B illustrate representative graphical user interfaces depicting requested content being displayed within a first content access time period;

FIGS. 7A and 7B illustrate representative graphical user interfaces depicting requested content being displayed within a subsequent supplemental content access time period;

FIGS. 8A and 8B illustrate a representative graphical user interface depicting a queries sent to a non-subscriber content requestor at the expiration of a first content access time period and a subsequent supplemental content access time period, respectively; and

FIG. 9 illustrates a schematic diagram of an exemplary hardware environment including a computing device that can be used to implement the embodiments described in FIGS. 1-8B.

### DETAILED DESCRIPTION

Embodiments disclosed herein disclose systems and methods configured to provide time-limited access to requested content by individual users, web-crawling entities or social media platform entities. For example, content such as text, images, audio, video, or combinations thereof, may be provided without charge or access requirements to one or more content requesting users or content requesting entities. After an initial content access period, the time-restricted content may be available to a non-subscriber content requestor only upon payment or when a user meets a particular subscriber access requirement condition, such as subscribing to a membership account that provides the content or an affiliate content providing site, performing a task or accessing other content.

Generally, the following disclosure describes three distinct types of media content that are arranged into two groups of the distinct media types. A first representative media type is an unrestricted media content type characterized in its distribution and access from the remaining media content types in that it is available to non-subscribers, (wherein a subscriber is a user or an entity that has a subscription account with the media content provider or service), and it is indefinitely available with respect to time after its initial publication time, (T_{P}).

A second representative media type is a subscriber media content type characterized in its distribution and access from the remaining media content types in that it is only available to subscribers of the media content provider or service and it is indefinitely available with respect to time after its initial publication time, (T_{P}). Generally, the subscriber media content type is always the same as the unrestricted media content type so as to provide subscribers with indefinite access to all media provided by the media content provider or service.

A third representative media type is a time-restricted media content type characterized in its distribution and access from the former media types in that it is available to non-subscribers of the media content provider or service only for a predetermined time after its initial publication time, (T_{P}). Generally, the subscriber media content type is always the same as the time-restricted media content type so as to provide subscribers with indefinite access to all media provided by the media content provider or service. However, time-restricted media content is never contemplated as being unrestricted media content as time-restricted media content always maintains at least one predetermined expiration time to prevent access by non-subscribers thereafter.

A first representative group of the above-referenced media types contemplated within this disclosure includes an unrestricted media content and the subscriber media content group. This first unrestricted/subscriber media content group anticipates the purpose of allowing both non-subscribers and subscribers, who typically access subscriber media content behind a subscriber paywall or subscriber log-in page, to access the unrestricted/subscriber media content group for an indefinite or continuous period of time (T_{C}).

A second representative group of the above-referenced media types contemplated within this disclosure includes the time-restricted media content and the subscriber media content group. This second time-restricted/subscriber media content group anticipates the purpose of allowing both non-subscribers and subscribers to access content of the unrestricted/subscriber media content group, whereas the non-subscribers may only access the time-restricted/subscriber media content for a predetermined period of time after its initial publication, T_{P}, as determined by the media content provider or service.

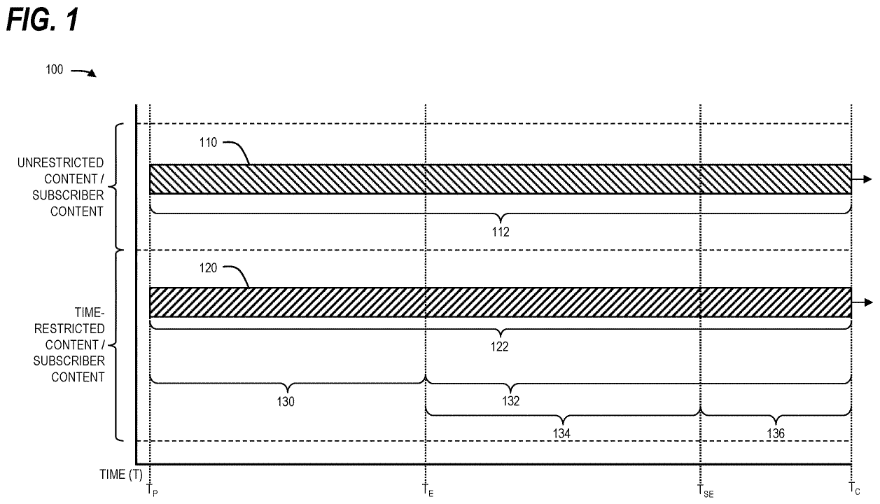

FIG. 1 illustrates a bar graph 100 depicting the above-described two groups of media content types along an X-axis of TIME (T): an unrestricted content/subscriber content group 110, and a time-restricted content/subscriber content group 120, both groups with respect to a publication time T_{P}, an expiration time T_{E}, a supplemental expiration time T_{SE}, and an indefinite continuous time T_{C}.

In one embodiment of providing content access to requesting user or entities, unrestricted content and/or subscriber content 110 is published at a time T_{P} for an unrestricted content access period 112, i.e., wherein access to the unrestricted/subscriber content 110 by content requesting user or entities is not time restricted and continues indefinitely as depicted by continuous time, T_{C}. For the purposes of clarity, any publication time, for example, T_{P}, for any type or group of media content contemplates the instance when a respective type of media is initially made accessible by the content provider or service to a respective content requesting user or entity.

In another embodiment of providing content access, FIG. 1 illustrates time-restricted/subscriber content 120 may be published at a time T_{P} for an unrestricted subscriber-only content access period 122. Subscriber access to the time-restricted/subscriber content 120 by content requesting subscribers, for example behind a paywall or via a subscriber log-in, is not restricted and continues indefinitely as depicted by a continuous time, T_{C}.

In another embodiment of providing content access, FIG. 1 illustrates time-restricted/subscriber content 120 may additionally contain a predetermined non-subscriber content access time period 130 expiring at an expiration time T_{E}. Thereafter, as denoted by bracket 132, the time-restricted/subscriber content 120 may no longer be accessible to the non-subscribers, and the time-restricted/subscriber content 120 may be inaccessible by any content requests made by any non-subscriber content requesting user or entity. However, a non-subscriber content requesting user or entity thereafter may subscribe to the content provider or service to enable access to the time-restricted/subscriber content 120 as a subscriber.

In another embodiment of providing content access, FIG. 1 illustrates time-restricted/subscriber content 120 may additionally contain a predetermined supplemental non-subscriber content access time period 134, (in addition to and after the predetermined non-subscriber content access time period 130), expiring at a supplemental expiration time T_{SE}. Thereafter, as denoted by bracket 136 the time-restricted/subscriber content 120 may no longer be accessible to the non-subscribers, and the time-restricted/subscriber content 120 may be inaccessible by any content requests made by any non-subscriber content requesting user or entity. However, a non-subscriber content requesting user or entity after the supplemental expiration time T_{SE} may subscribe to the content provider or service to enable access to the time-restricted/subscriber content 120 as a subscriber.

In one embodiment, a time indicator may be displayed for non-subscribers accessing the time-restricted/subscriber content 120 as an expiration time indicator that may include a day, an hour, a minute, a second and a time-zone designation indicating an expiration time of the predetermined non-subscriber content access time period 130 at T_{E}, or the supplemental non-subscriber content access time period 134 at T_{SE} of FIG. 1.

In another embodiment, the time indicator may also be displayed for non-subscribers accessing the time-restricted/subscriber content 120 as a count-down timer indicating a remaining time to the expiration time of the predetermined non-subscriber content access time period 130 at T_{E}, or the supplemental non-subscriber content access time period 134 at T_{SE} of FIG. 1.

The time indicator display may be shown concurrently with the time-restricted/subscriber content 120 itself, with previews of the time-restricted/subscriber content 120, with additional versions of the time-restricted/subscriber content 120, and/or in other suitable locations, for example, a) to reward regular non-subscribers accessing websites by offering regular new time-restricted content which they would miss if they visited the website less regularly, b) to create the psychological effect of “missing out” if non-subscribers fail to read the currently available time-restricted content before it expires, c) to enable non-subscribers to view subscriber content without a need to for subscriber registration, d) to reinforce the convenience advantage of the Subscriber Service by viewing content on-demand, rather than a non-subscriber having to visit the time-restricted content source only during the time-restricted content period, and/or e) to allow search engines and social media platforms access to content directly after it has been published to create a positive effect on their algorithms and drive more traffic to the content.

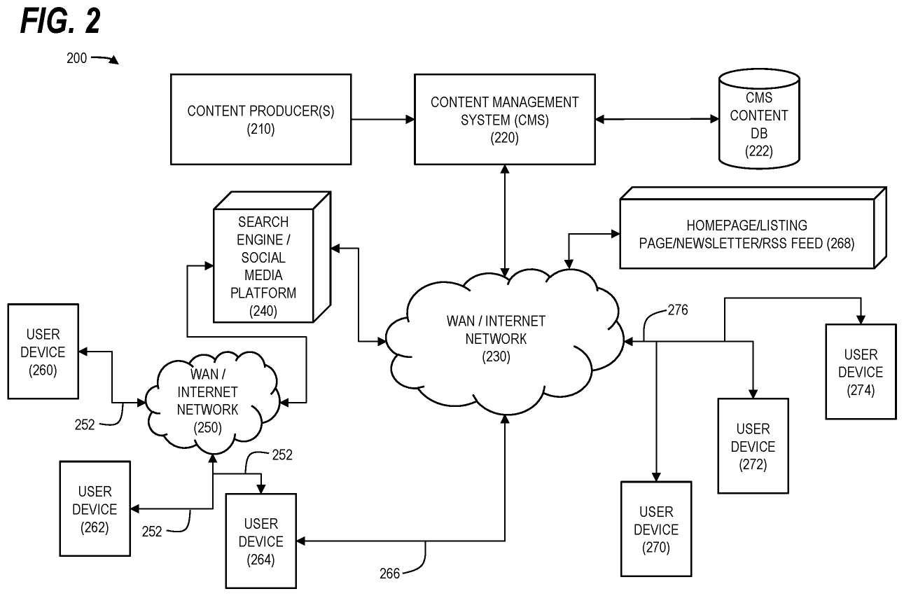

FIG. 2 illustrates a schematic diagram of a content providing system 200 including a content management system 220 configured to provide content to user devices 260, 262, 264, 270, 272 and 274. Content creators 210 produce and submit electronic media content including at least one of written articles, graphic images, audio and video to a Content Management System (CMS) 220 in anticipation of publishing the content to the respective user devices.

CMS 220 may store and retrieve the received content in the CMS content database 222 that may be local to or remote from the CMS 220. CMS 220 may categorize and group the received content consistent with the above disclosure of FIG. 1, where content may be initially categorized as unrestricted, time-restricted or subscriber content. The categorized content may further be grouped into content groups of 1) unrestricted/subscriber content 110 and 2) time-restricted/subscriber content 120, (see FIG. 1). Thereafter, CMS 220 may publish the content groups via a first wide area network (WAN)/internet network 230 to be accessed by search engines and social media platforms 240 and respective user devices 260-264, a CMS 220 managed homepage/listing page/newsletter/RSS feed 268 and respective user devices 270-274.

In a first embodiment, the CMS 220 publishes content groups via a URL that may be accessed via a web-crawler of a search engine or a social media platform 240 that may then distribute the published content groups to respective search engine user devices or social media platform subscriber devices 260, 262 and 264, respectively, via a second wide area network (WAN)/internet network 250. The second WAN/internet network 250 may be one in the same as or different from the first WAN/internet network 230.

Communication 252 generated between the respective search engine user devices or social media platform subscriber devices (260, 262 and 264) and the search engine or social media platform 240 may continue via the second WAN/internet network 250 for at least the duration of a non-subscriber time-restricted content access time period of the CMS 220 published content groups, (see for example, the predetermined non-subscriber content access time period 130 expiration time T_{E}, and the supplemental non-subscriber content access time period 134 supplemental expiration time T_{SE} of FIG. 1).

In one embodiment, the respective search engine user devices or social media platform subscriber devices (260, 262 and 264) may request 266 any of the types of published content groups directly from the CMS 220 based on the communication 252 generated between the respective search engine user devices or social media platform subscriber devices (260, 262 and 264) and the search engine or social media platform 240, respectively. In another embodiment, respective user devices 270, 272 and 274 may request access to any of the types of the published content from the CMS 220.

However, in both of the above embodiments where the non-subscriber identified user devices request time-restricted/subscriber content 120 from the CMS 220, at the time of expiration T_{E} of the non-subscriber content access time period 130 arrives, all non-subscriber user devices that do not have a subscription to the subscriber content portion of the time-restricted/subscriber group of content, (e.g., FIG. 1, 120), will have their access to the content revoked.

After access is revoked from a respective search engine user device or social media platform non-subscriber devices, (e.g., 264), a user via their device may request 266 the time-restricted content directly from the CMS 220 or the CMS 220 managed homepage/listing page/newsletter/RSS feed 268 based on the communication 252 generated between the respective search engine user devices or social media platform subscriber devices (260, 262 and 264) and the search engine or social media platform 240. Likewise, after access is revoked from a respective non-subscriber user device (e.g., 270), the user via their device may request 276 the time-restricted/subscriber content directly from the CMS 220 via the CMS 220 managed homepage/listing page/newsletter/RSS feed 268.

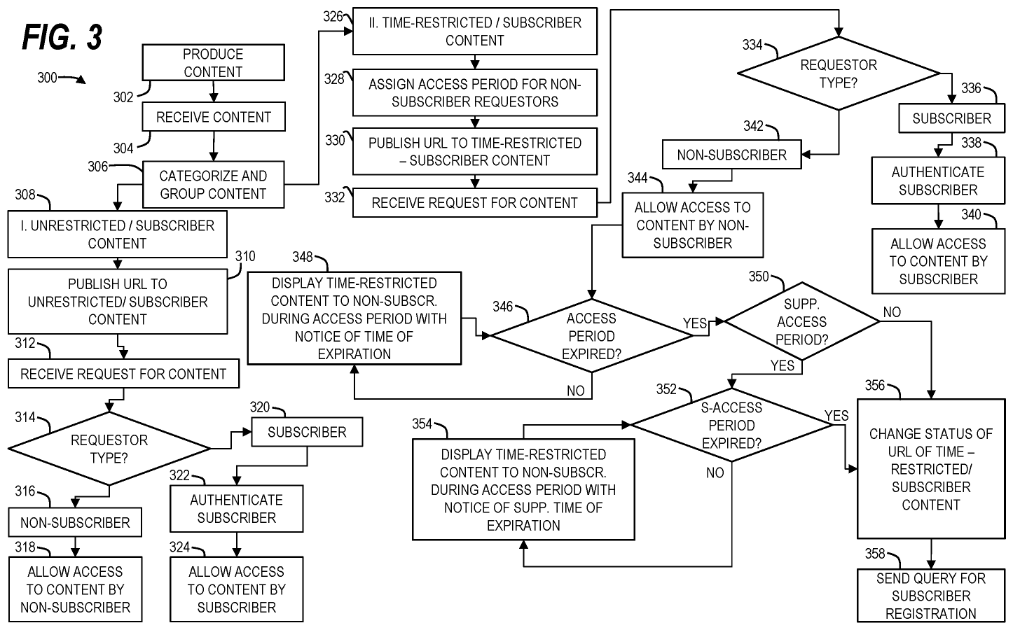

FIG. 3 illustrates a logical flowchart of a method 300 of providing content by the CMS 220 to a device of any type of content requestor. The method starts where a content creator produces 302 media content that is sent and received 304 by the CMS 220 (see, FIG. 2). The CMS 220 categorizes 306 the received media content as being either unrestricted media content, time-restricted media content or subscriber media content. The CMS 220 may categorize the received media based on predetermined media categories received with the media from the content producer 210 or may categorize the media independent of the presence or absence of any media category types.

The CMS 220 may further group the categorized content into at least two groups of categorized media content: I.) unrestricted/subscriber content, (see FIG. 1, 110), and II.) time-restricted/subscriber content, (see FIG. 1, 120).

If the received content is either determined or assigned to be unrestricted/subscriber content 308, a publication time for the unrestricted/subscriber content is one of assigned or determined and the unrestricted/subscriber content URL is published 310, (or expressly transmitted to a user or entity), at that publication time T_{P}. As described above, the publication of the URL may be via a search engine or social media network platform and/or to a CMS managed webpage/listing page/newsletter/RSS feed for user device access thereto.

Thereafter, the CMS 220 may receive an access request 312 for the unrestricted/subscriber content from at least one of a search engine web crawler, a social media platform, or user operating a user device based on the publication of the URL via the search engine or social media network platform and/or the CMS managed webpage/listing page/newsletter/RSS feed.

The CMS 220 may determine the type of requestor 314 providing the access request by determining if the requestor is either a subscriber to the CMS provided content or a non-subscriber merely requesting access to the CMS provided content.

If the received request for content is determined to be a non-subscriber 316, for example, where the request for content access did not include subscriber information, subscriber login credentials or provide cookies with similar credential access information, the access to the unrestricted/subscriber content is granted to allow access 318 to the requested content by the non-subscriber for an indefinite period of time.

If the received request for content is determined to be a subscriber 320, for example, where the request for content access includes subscriber information, subscriber login credentials or provides cookies with similar credential access information, access to the unrestricted/subscriber content is granted through a subscriber paywall or login portal upon authentication of the subscriber 322 to allow access 324 to the requested content by the subscriber for an indefinite period of time.

If the received content is either determined or assigned to be time-restricted/subscriber content 326, a publication time, T_{P}, for the time-restricted/subscriber content is one of assigned or determined, an access period with a time of expiration, T_{E}, is one of assigned or determined 328 for the time-restricted/subscriber content, and the time-restricted/subscriber content URL is published 330 at that publication time, T_{P}. As described above, the publication of the URL may be via a search engine or social media network platform and/or to a CMS managed webpage/listing page/newsletter/RSS feed for user device access thereto.

Thereafter, the CMS 220 may receive an access request 332 for the time-restricted/subscriber content from at least one of a search engine web crawler, a social media platform, or user operating a user device based on the publication of the URL via the search engine or social media network platform and/or the CMS managed webpage/listing page/newsletter/RSS feed.

The CMS 220 may determine the type of requestor 334 providing the access request by determining if the requestor is either a subscriber to the CMS provided content or a non-subscriber merely requesting access to the CMS provided content.

If the received request for content is determined to be a non-subscriber 342, for example, where the request for content access did not include subscriber information, subscriber login credentials or provide cookies with similar credential access information, the access to the time-restricted/subscriber content is granted to allow access 318 to the requested content by the non-subscriber subject to the predetermined access period of time having a time of expiration, T_{E}, and any predetermined supplemental access period of time having a supplemental time of expiration, T_{SE}, described below.

If the determined non-subscriber 342 is allowed access 344 to the time-restricted/subscriber content, the CMS first determines if the access period of time has expired 346. If the access period of time has not expired, then the requested time-restricted/subscriber content may be displayed 348 to the non-subscriber for the predetermined access period of time with the notice of time expiration, described above, as either the time of expiration or a count-down timer to the time of expiration, T_{E}.

If the access period of time has been determined to have expired 346, a determination is made as to whether a supplemental content access period exists 350 subsequent to the initial content access period. If a supplemental content access period is determined to exist 350, then a determination is made as to whether the supplemental content access period has expired 352. If the supplemental content access period has not expired, then the requested time-restricted/subscriber content may be displayed 354 to the non-subscriber for the predetermined supplemental access period of time with the notice of time expiration, described above, as either the time of expiration or a count-down timer to the supplemental time of expiration, T_{SE}.

If the supplemental content access period has been determined to have expired 352, or the supplemental content access period does not exist 350, the status of the published URL to the time-restricted/subscriber content is changed 356 to no longer allow non-subscriber access to the time-restricted/subscriber content. Thereafter, the CMS 220 sends a query to the device of the requesting user or entity for subscriber registration to continue to have access to the now time-restricted media content as a subscriber via a subscriber paywall or the like.

If the received request for content is determined 334 to be a subscriber 336, for example, where the request for content access includes subscriber information, subscriber login credentials or provides cookies with similar credential access information, access to the unrestricted/subscriber content is granted through a subscriber paywall or login portal upon authentication of the subscriber 338 to allow access 340 to the requested content by the subscriber for an indefinite period of time.

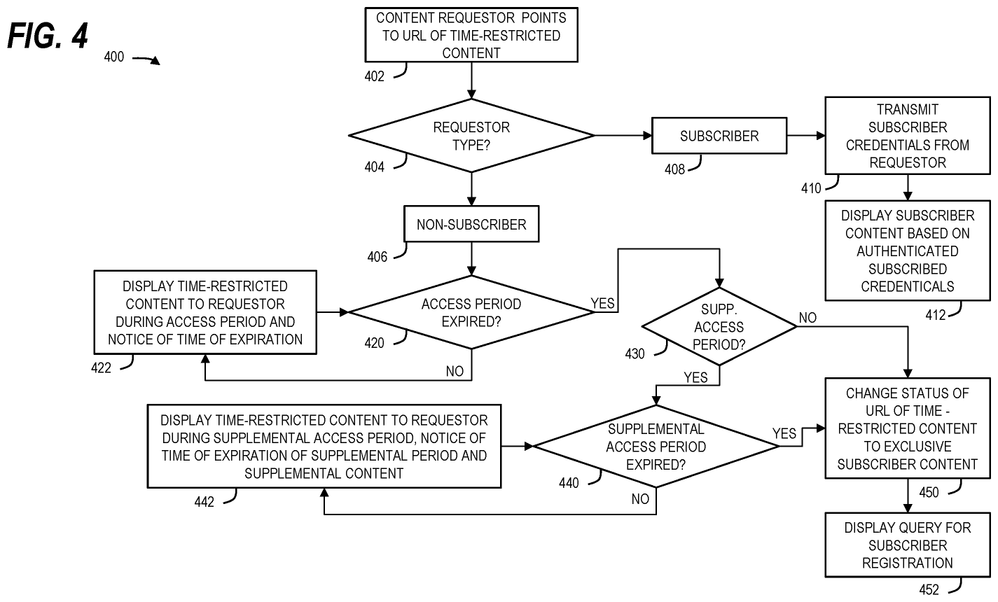

FIG. 4 illustrates a logical flowchart of a method 400 of providing a user interface on a content requestor device. The method begins by a content requestor pointing 402 to a uniform resource locator (URL) of time-restricted/subscriber content, either accessed directly via the CMS 220 of FIG. 2 or via a search engine or social media platform 240 of FIG. 2.

The CMS 220, upon receiving the content request from the user device, determines 404 the requestor type of the content requestor: i.e., whether the content requestor is a non-subscriber 406 to subscriber content provided by the CMS 220, or is a subscriber 408 to subscriber content provided the CMS 220.

If the content requestor is determined to be a subscriber 408 to the subscriber content provided by the CMS 220, the user via the user device may transmit 410 the subscriber credentials to the CMS 220 for validation to access to the subscriber content. After validation by the CMS 220, the user device may display 412 the subscriber content based on the authenticated provided subscriber credentials without any time limit to the subscriber content.

If the request is determined to be from a non-subscriber content requestor 406, (at the CMS 220), a subsequent determination is made as to whether the content access time period has expired 420.

If the content access time period has not expired, the categorized time-restricted content is displayed 422 to the non-subscriber content requestor in conjunction with a notice of a time of expiration of the content access time period, and access is allowed to the time-restricted/subscriber content only during the content access time period.

If the content access time period is determined 420 to have expired, a subsequent determination is made as to whether 430 a supplemental content access time period exists for the time-restricted/subscriber content 120.

If a supplemental content access time period for the time-restricted/subscriber content is determined 430 to exist, a subsequent determination is made as to whether 440 a supplemental content access time period has expired.

If a supplemental content access time period for the time-restricted/subscriber content is determined to have not expired 440, the time-restricted/subscriber content may be displayed 442 in conjunction with a notice of a supplemental time of expiration of the supplemental content access time period, and access may be allowed to the time-restricted/subscriber content during the supplemental content access time period and may be displayed in conjunction with supplemental media content for at least a portion of the supplemental content access time period.

If a supplemental content access time period has been determined 430 to not exist, or if a determination 440 is made that the supplemental content access time period has expired, the URL to the time-restricted/subscriber content is changed 450 to prevent access thereto from any non-subscriber content requestors, to thereby allow access only to subscribers via a subscriber paywall or the like.

Thereafter, and based on the supplemental content access time period being determined 430 to not exist, or the determination 440 that the supplemental content access time period has expired, the CMS 220 may further prompt, transmit or send a query to be displayed 452 on a non-subscriber content requesting user device to provide registration information to enable access to subscriber content portion of the time-restricted/subscriber content 120 as a determined subscriber type of a content requestor via a subscriber paywall or the like.

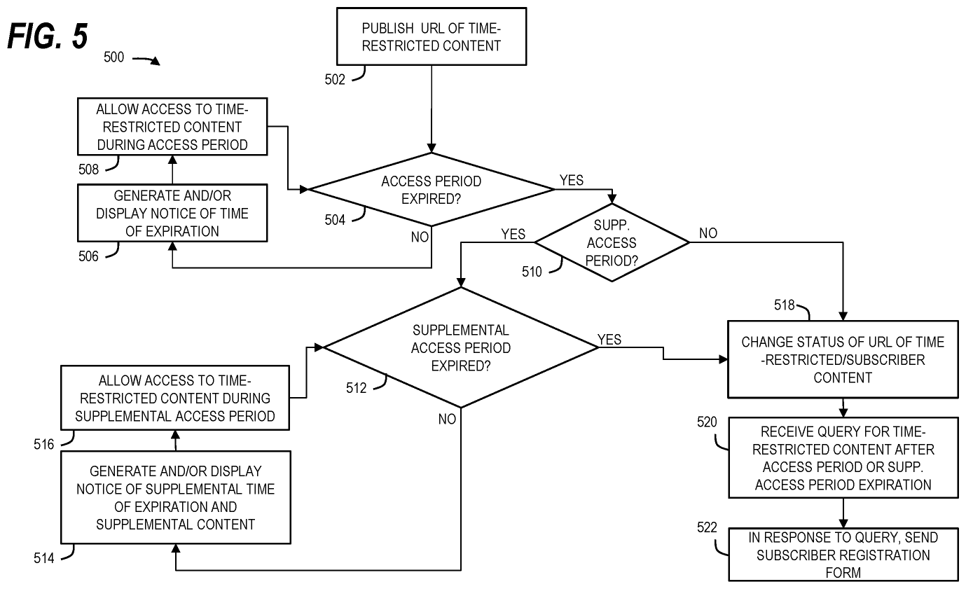

FIG. 5 illustrates a logical flowchart of a method 500 of receiving a query for content after an expiration of a content access period of time or a supplemental access period of time. The method begins by publishing 502, (or directly transmitting the URL to a device or entity), at publication time T_{P}, the time-restricted/subscriber content 120 for access by non-subscriber requestor devices.

If a determination 504 is made that the content access time period has not expired, the method generates and/or displays 506 a notice of a time of expiration of the content access time period with the published time-restricted/subscriber content 120, and access is allowed 508 to the time-restricted/subscriber content 120 during the content access time period.

If the content access time period is determined 504 to have expired, a determination is made as to whether 510 a supplemental content access time period exists for the published time-restricted/subscriber content 120.

If a supplemental content access time period has been determined 336 to exist, a determination is made as to whether 512 a supplemental content access time period has expired.

If a supplemental content access time period has not expired, the time-restricted/subscriber content may be displayed in conjunction with a generated 514 notice of a supplemental time of expiration of the supplemental content access time period, and access may be allowed 516 to the time-restricted/subscriber content during the supplemental content access time period.

If a supplemental content access time period been determined 510 to not exist, or if a determination 512 is made that the supplemental content access time period has expired, the URL of the time-restricted/subscriber content is changed 518 to prevent access thereto by any non-subscriber content requestors, to thereby allow access only to subscribers via a subscriber paywall or the like.

The CMS 220, (see FIG. 2), may thereafter receive a query 520 for the time-restricted/subscriber content 120 by a non-subscriber after expiration of the content access time period T_{E} and/or after the expiration of the supplemental content access time period T_{SE}. The query may be in response to communication generated or curated by one of a search engine or a social media platform based on time-restricted/subscriber content before reaching the expiration of the content access time period T_{E} and/or the expiration of the supplemental content access time period T_{SE}.

Based receiving the query for the time-restricted/subscriber content after the expiration of the content access time period and/or the supplemental content access time period, the CMS 220 may prompt, publish or send 522 a query to the time-restricted/subscriber content requesting user device to register as a subscriber for access to the time-restricted/subscriber content only available as subscriber content 120.

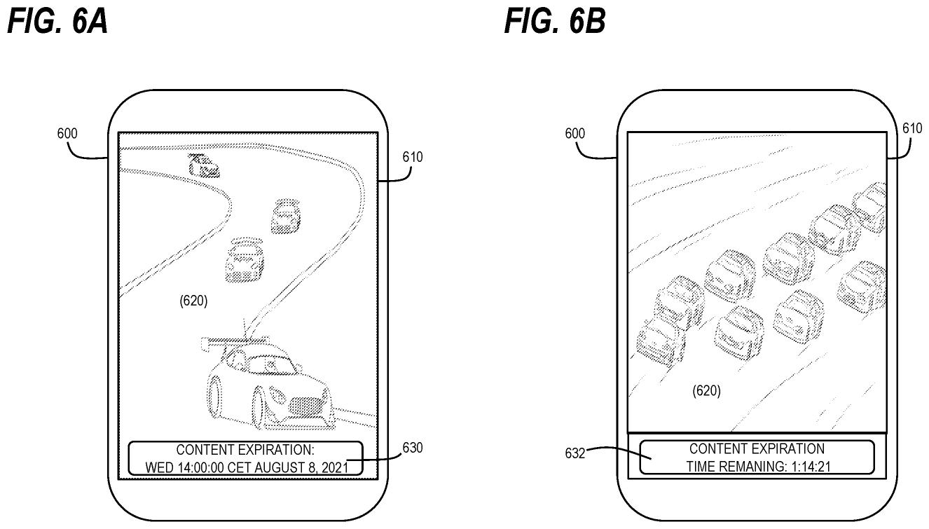

FIGS. 6A and 6B illustrate representative graphical user interfaces of a content requesting user device 600 depicting requested time-restricted/subscriber content 620 being displayed on a display device 610 within a first content access time period.

FIG. 6A illustrates requested time-restricted/subscriber content 620 being displayed in conjunction with a notice of content expiration 630 of the first content access time period. The notice of content expiration 630 may be one of superimposed on the time-restricted/subscriber content, (as shown in FIG. 6A), or may be displayed outside of the time-restricted/subscriber content, (as shown in FIG. 6B). The notice of content expiration 630 may include an expiration time designation of at least one of a day, an hour, a minute, a second, a time zone designation, a month, a date and a year. The expiration time of the time-restricted/subscriber content is based on the publication time and controlled by the CMS 220 content publication server, not based on the user location, user device or the user time zone where the user device is located.

FIG. 6B illustrates requested time-restricted/subscriber content 620 being displayed in conjunction with a content expiration count-down clock 632 indicating a remaining time of the first content access time period. The notice of content expiration 632 may be one of superimposed on the time-restricted/subscriber content, (as shown in FIG. 6A), or may be displayed outside of the time-restricted/subscriber content, (as shown in FIG. 6B). The notice of content expiration 630 may include a count-down clock or timer including at least one of an hour, a minute, and a second.

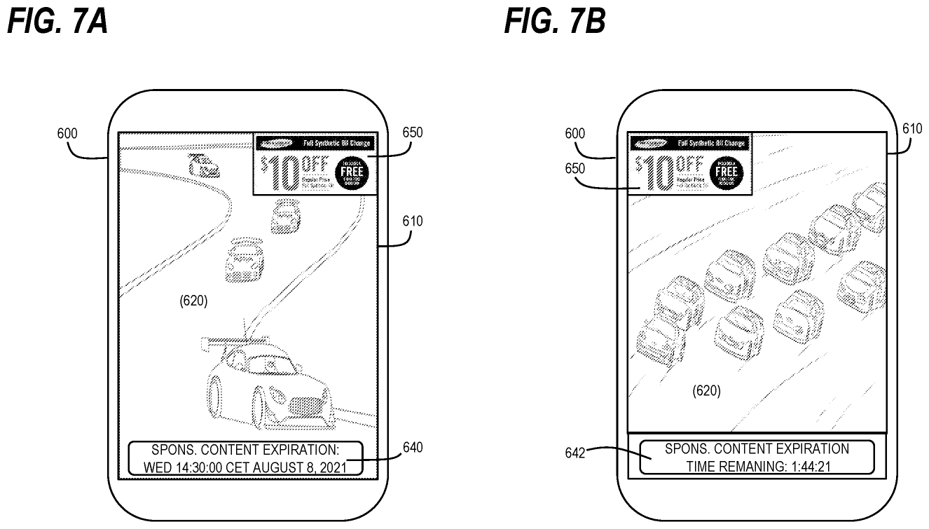

FIGS. 7A and 7B illustrate representative graphical user interfaces of a content requesting user device 600 depicting requested content 620 being displayed on a display device 610 within a subsequent supplemental content access time period.

FIG. 7A illustrates requested time-restricted/subscriber content 620 being displayed in conjunction with a supplemental, (or, e.g., a “sponsored”), notice of content expiration 640 of the supplemental content access time period. (Note, an exemplary supplemental content access time period of 30 minutes has been added to the expiration time 610 and expiration count-down clock 620 of FIGS. 6A and 6B, respectively.) The supplemental notice of content expiration 640 may be one of superimposed on the time-restricted/subscriber content, (as shown in FIG. 7A), or may be displayed outside of the time-restricted/subscriber content, (as shown in FIG. 7B). The supplemental notice of content expiration 640 may include a supplemental expiration time designation of at least one of a day, an hour, a minute, a second, a time zone designation, a month, a date and a year.

FIG. 7B illustrates requested time-restricted/subscriber content 620 being displayed in conjunction with a supplemental, (or, e.g., a “sponsored”), content expiration count-down clock 642 indicating a remaining time of the supplemental content access time period. The supplemental notice of content expiration 642 may be one of superimposed on the time-restricted/subscriber content, (as shown in FIG. 7A), or may be displayed outside of the time-restricted/subscriber content, (as shown in FIG. 7B). The supplemental notice of content expiration 630 may include a count-down clock or timer displaying at least one of an hour, a minute, and a second.

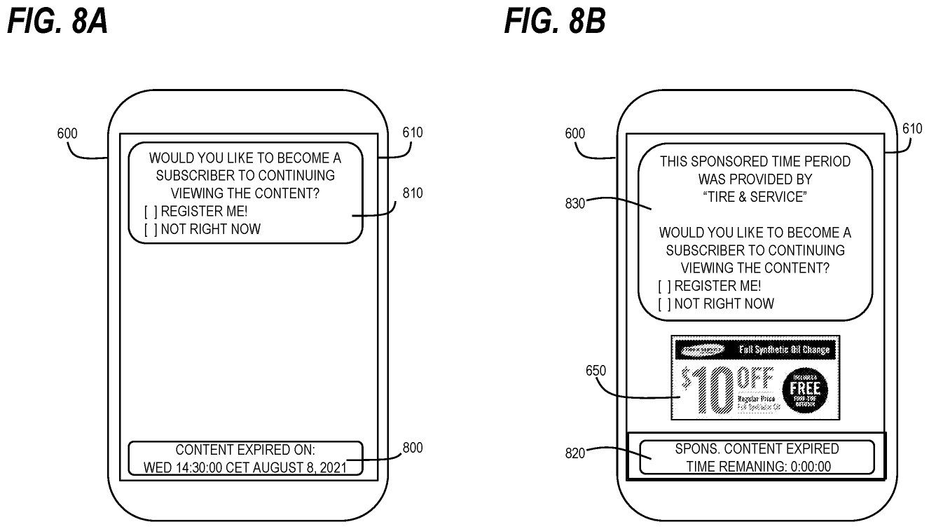

FIGS. 7A and 7B illustrate a supplemental content 650 that may be displayed in conjunction with the time-restricted/subscriber content 620. For example, a sponsor may purchase advertising rights with the CMS 220 to “sponsor” a supplemental content access time period at the end of a content access time period to thereby lengthen the original content access time period with the supplemental access time period and may display or produce in conjunction with the time-restricted/subscriber content supplemental, or “sponsor-based” content. FIGS. 7A, 7B and 8B illustrate a graphic display of a coupon or advertisement that may be included as or with the supplemental content 650.

FIG. 8A illustrates a representative graphical user interface of a content requesting user device 600 no longer displaying the requested content 620 upon expiration of a first content access time period, wherein the content expiration display with time and date of expiration 630 of FIG. 6A is replaced with an expiration notice of time-restricted/subscriber content 800. Based on the expiration of the content access time period, a subscription registration query 810 is further displayed on the user device 600 prompting the user to one of input subscriber registration information or directions on how to become a registered subscriber.

FIG. 8B illustrates a representative graphical user interface of a content requesting user device 600 no longer displaying the requested content 620 upon expiration of a supplemental content access time period, wherein the supplemental content expiration display with the supplemental expiration count-down clock 642 of FIG. 7B is replaced with a supplemental, (or, “sponsor”), expiration notice of time-restricted/subscriber content 820. Based on the expiration of the supplemental content access time period, a supplemental subscription registration query 830 is further displayed on the user device 600 that may indicate a “sponsor” of the supplemental content access time period and further prompt the user to one of input subscriber registration information or directions on how to become a registered subscriber.

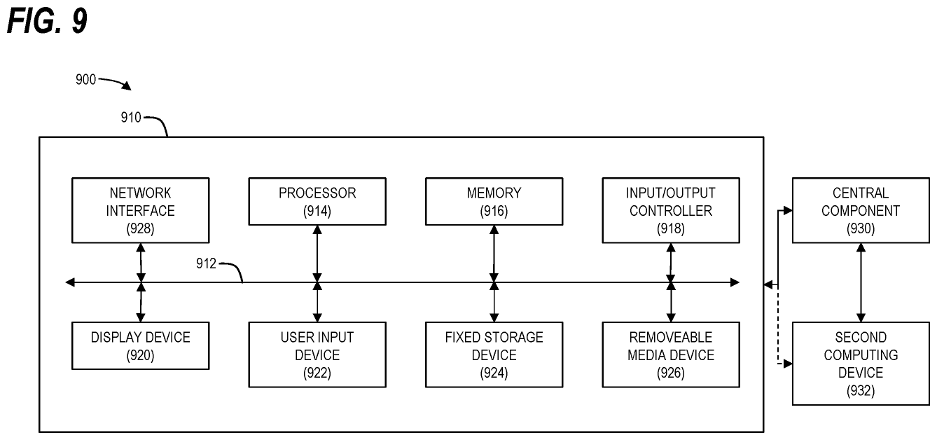

FIG. 9 illustrates a schematic diagram of an exemplary hardware environment including a computing device that may be used to implement either of the CMS 220 and the user devices of FIG. 2 in the embodiments described in FIGS. 1-8B.

Implementations of the presently disclosed subject matter may be implemented in and used with a variety of component and network architectures. FIG. 9 is an example computer environment 900 and an example computer 910 suitable for implementing implementations of the presently disclosed subject matter, and particularly the content management system (CMS) 220 of FIG. 2. As discussed in further detail herein, the computer 910 may be a single computer in a network of multiple computers. As shown in FIG. 9, computer 910 may communicate with a central component 930 (e.g., server, cloud server, database, etc.). The central component 930 may communicate with one or more other computers such as the second computer 932. According to this implementation, the information obtained to and/or from a central component 930 may be isolated for each computer such that computer 910 may not share information with computer 932. Alternatively, or in addition, computer 910 may communicate directly with the second computer 932.

The computer (e.g., user computer, enterprise computer, etc.) 910 includes a bus 912 which interconnects major components of the computer 910, such as a central processor 914, a memory 916, (typically RAM, but which may also include ROM, flash RAM, or the like), an input/output controller 918, a user display 920, such as a display or touch screen via a display adapter, a user input interface 922, which may include one or more controllers and associated user input or devices such as a keyboard, mouse, WIFI/cellular radios, touchscreen, microphone/speakers and the like, and may be closely coupled to the I/O controller 918, fixed storage 924, such as a hard drive, flash storage, Fiber Channel network, SAN device, SCSI device, and the like, and a removable media component 926 operative to control and receive an optical disk, flash drive, and the like.

The bus 912 enable data communication between the central processor 24 and the memory 916, which may include read-only memory (ROM) or flash memory (neither shown), and random-access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 910 can be stored on and accessed via a computer readable medium, such as a hard disk drive (e.g., fixed storage 924), an optical drive, floppy disk, or other storage medium 926.

The fixed storage 924 may be integral with the computer 910 or may be separate and accessed through other interfaces. A network interface 928 may provide a direct connection to a remote server via a telephone link, to the Internet via an internet service provider (ISP), or a direct connection to a remote server via a direct network link to the Internet via a POP (point of presence) or other technique. The network interface 928 may provide such connection using wireless techniques, including digital cellular telephone connection, Cellular Digital Packet Data (CDPD) connection, digital satellite data connection or the like. For example, the network interface 928 may enable the computer to communicate with other computers via one or more local, wide-area, or other networks.

Many other devices or components (not shown) may be connected in a similar manner (e.g., document scanners, digital cameras and so on). Conversely, all of the components shown in FIG. 9 need not be present to practice the present disclosure. The components can be interconnected in different ways from that shown. The operation of a computer such as that shown in FIG. 9 is readily known in the art and is not discussed in detail in this application. Code to implement the present disclosure can be stored in computer-readable storage media such as one or more of the memory 916, fixed storage 924, removable media 926, or on a remote storage location.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to generate specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general-purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The embodiments disclosed herein have advantages over conventional media publication systems which provide electronic media content to content requesting users typically requiring each content requesting user device to be identified and tracked via cookies or equivalent content requesting user device tracking methods. Conventional systems that rely upon the use of cookies or similar techniques to identify content requestors consume large amounts of computing power and communication resources to enable logging of each content requesting user for each requested media content from the time of the original content request through the time the content requesting user is finished with consumption of the requested content. The embodiments presented herein eliminate the need for tracking/logging/communicating of content requesting user information by time-restricted/subscriber content 120 that is independent of any content requesting user specifics, e.g., independent of information of the device or devices used by a content requesting user, and independent of a time zone(s) where that device or those devices of the content requesting user are located relative to the time zone of the media content publication managing server.

As a result of not tracking content requestor information, the advantages of the embodiments disclosed herein provide a reduction in processing resources for the media content publication managing server, (e.g., the content managing service 220 of FIG. 2, later described), a reduction in communication bandwidth requirements for communication networks supporting communication between the media content publication managing service and corresponding content requesting user devices, and a reduction in processing resources and communication bandwidth requirements for the end-user content requesting devices, less and/or no processing of personal user data and thereby limits the necessity of GDPR reporting requirements.

In summary, one embodiment presented herein includes a method of providing access to electronic media content, including associating a content access time period with the electronic media content, providing a uniform resource locator (URL) to the content at a publication time, receiving a content access request from at least one content requesting entity, determining a type of requesting entity of the at least one content requesting entity, providing access to the content via the URL, based on the determining of the type of requesting entity, to the at least one content requesting entity from the publication time until an expiration of the content access time period, and providing a subscription query, based on reaching the expiration of the content access time period, to the at least one content requesting entity.

The above embodiment of providing electronic media content further includes modifying the URL, based on reaching the expiration of the content access time period, wherein modifying the URL is configured to stop providing access to the content via the URL by the at least one content requesting entity on and after the expiration of the content access time period based on the determining of the type of requesting entity.

In the above embodiment of providing electronic media content, the content access time period is configured to be a fixed period of time independent of a difference between time zones of the at least one content requesting entity and a content providing server, and at least two devices associated with the at least one content requesting entity.

In the above embodiment of providing electronic media content, providing access to the content via the URL to the at least one content requesting entity at the publication time further includes providing a time indicator associated with the expiration of content access time period.

In the above embodiment of providing electronic media content, the time indicator further includes one of an expiration time of the content access time period, or a countdown timer of a remaining time to the expiration of the content access time period.

In the above embodiment of providing electronic media content, providing the subscription query further includes indicating at least one access requirement to be taken by the at least one content requesting entity configured to allow the at least one content requesting entity to access the content after the expiration of the content access time period.

In the above embodiment of providing electronic media content, the method further includes receiving the at least one access requirement by the at least one content requesting entity, determining a second type of requesting entity of the at least one content requesting entity based on receiving the at least one access requirement, providing access to the content via the URL, based on the determining of the second type of requesting entity, to the at least one content requesting entity after the expiration of the content access time period.

In summary, a further embodiment presented herein includes a method of providing access to electronic media content including associating a content access time period with the electronic media content, providing a uniform resource locator (URL) to the content at a publication time, receiving a content access request from at least one content requesting entity, determining a type of requesting entity of the at least one content requesting entity, providing access to the content via the URL, based on the determining of the type of requesting entity, to the at least one content requesting entity from the publication time until an expiration of the content access time period, providing continued access to the content via the URL after the expiration of the content access time period to the at least one content requesting entity until a second expiration of a supplemental content access time period, and providing a subscription query, based on reaching the second expiration of the supplemental content access time period, to the at least one content requesting entity.

The above embodiment of providing electronic media content further includes modifying the URL, based on reaching the second expiration of the supplemental content access time period, wherein modifying the URL is configured to stop providing access to the content via the URL by the at least one content requesting entity on and after the second expiration of the supplemental content access time period based on the determining of the type of requesting entity.

In the above embodiment of providing electronic media content, the content access time period is configured to be a fixed period of time independent of a difference between time zones of the at least one content requesting entity and a content providing server, and at least two devices associated with the at least one content requesting entity.

In the above embodiment of providing electronic media content, the supplemental content access time period is configured to be a supplemental fixed period of time independent of a difference between time zones of the at least one content requesting entity and a content providing server, and at least two devices associated with the at least one content requesting entity.

In the above embodiment of providing electronic media content, providing access to the content via the URL to the at least one content requesting entity at the publication time further includes providing a time indicator associated with one of the expiration of content access time period and the second expiration of the supplemental access time period.

In the above embodiment of providing electronic media content, the time indicator further includes an expiration time of at least one of the content access time period and the supplemental content access time period, or a countdown timer of a remaining time to an expiration time of one of the content access time period and the supplemental content access time period.

In the above embodiment of providing electronic media content, providing the subscription query further includes indicating at least one access requirement to be taken by the at least one content requesting entity configured to allow the at least one content requesting entity to access the content after one of the expiration of the content access time period and the second expiration of the supplemental content access period.

In the above embodiment of providing electronic media content, providing continued access to the content via the URL after the expiration of the content access time period until the second expiration of the supplemental content access time period further includes providing supplemental electronic media content presented with the content during at least a portion of the supplemental content access time period.

In summary, one further embodiment presented herein includes a content access management system including a memory configured to store processor instructions configured to provide access to electronic media content for a content requesting entity, a processor, in communication with the memory, configured to execute the processor instructions, a storage device, in communication with the processor, configured to store and retrieve the electronic media content, and a media server, in communication with the processor and the storage device. The media server being configured to associate a content access time period with the electronic media content, to provide a uniform resource locator (URL) to the content at a publication time, to receive a content access request from at least one content requesting entity, to determine a type of requesting entity of the at least one content requesting entity, to provide access to the content via the URL, based on the determining of the type of requesting entity, to the at least one content requesting entity from the publication time until an expiration time of the content access time period, and to provide a subscription query, based on reaching the expiration time of the content access time period, to the at least one content requesting entity.

In the above embodiment of providing electronic media content, the media server is further configured to append a supplemental content access time period to the expiration time of the content access time period, and to provide continued access to the content via the URL after the expiration time of the content access time period to the at least one content requesting entity until a second expiration time of a supplemental content access time period.

In the above embodiment of providing electronic media content, providing continued access to the content via the URL after the expiration time of the content access time period until the second expiration time of the supplemental content access time period further includes providing supplemental electronic media content presented with the content during at least a portion of the supplemental content access time period.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

What is claimed is:

1. A method of providing access to electronic media content, the method comprising:
associating a content access time period with the electronic media content;
providing a uniform resource locator (URL) to the content at a publication time;
receiving a content access request from at least one content requesting entity;
determining a type of requesting entity of the at least one content requesting entity;
providing access to the content via the URL, based on the determining of the type of requesting entity, to the at least one content requesting entity from the publication time until an expiration of the content access time period; and
providing a subscription query, based on reaching the expiration of the content access time period, to the at least one content requesting entity.

2. The method of providing access to electronic media content according to claim 1, further comprising modifying the URL, based on reaching the expiration of the content access time period, wherein modifying the URL is configured to stop providing access to the content via the URL by the at least one content requesting entity on and after the expiration of the content access time period based on the determining of the type of requesting entity.

3. The method of providing access to electronic media content according to claim 1,
wherein the content access time period is configured to be a fixed period of time independent of a difference between time zones of the at least one content requesting entity and a content providing server, and
at least two devices associated with the at least one content requesting entity.

4. The method of providing access to electronic media content according to claim 1,
wherein providing access to the content via the URL to the at least one content requesting entity at the publication time further comprises providing a time indicator associated with the expiration of content access time period.

5. The method of providing access to electronic media content according to claim 4, wherein the time indicator further comprises an expiration time of the content access time period.

6. The method of providing access to electronic media content according to claim 4, wherein the time indicator further comprises a countdown timer of a remaining time to the expiration of the content access time period.

7. The method of providing access to electronic media content according to claim 1, wherein providing the subscription query indicates at least one access requirement to be taken by the at least one content requesting entity configured to allow the at least one content requesting entity to access the content after the expiration of the content access time period.

8. The method of providing access to electronic media content according to claim 7, the method further comprising:
receiving the at least one access requirement by the at least one content requesting entity;
determining a second type of requesting entity of the at least one content requesting entity based on receiving the at least one access requirement; and
providing access to the content via the URL, based on the determining of the second type of requesting entity, to the at least one content requesting entity after the expiration of the content access time period.

9. A method of providing access to electronic media content, the method comprising:
associating a content access time period with the electronic media content;
providing a uniform resource locator (URL) to the content at a publication time;
receiving a content access request from at least one content requesting entity;
determining a type of requesting entity of the at least one content requesting entity;
providing access to the content via the URL, based on the determining of the type of requesting entity, to the at least one content requesting entity from the publication time until an expiration of the content access time period;
providing continued access to the content via the URL after the expiration of the content access time period to the at least one content requesting entity until a second expiration of a supplemental content access time period; and
providing a subscription query, based on reaching the second expiration of the supplemental content access time period, to the at least one content requesting entity.

10. The method of providing access to electronic media content according to claim 9, further comprising modifying the URL, based on reaching the second expiration of the supplemental content access time period, wherein modifying the URL is configured to stop providing access to the content via the URL by the at least one content requesting entity on and after the second expiration of the supplemental content access time period based on the determining of the type of requesting entity.

11. The method of providing access to electronic media content according to claim 9, wherein the content access time period is configured to be a fixed period of time independent of
a difference between time zones of the at least one content requesting entity and a content providing server, and
at least two devices associated with the at least one content requesting entity.

12. The method of providing access to electronic media content according to claim 9, wherein the supplemental content access time period is configured to be a supplemental fixed period of time independent of
a difference between time zones of the at least one content requesting entity and a content providing server, and
at least two devices associated with the at least one content requesting entity.

13. The method of providing access to electronic media content according to claim 9, wherein providing access to the content via the URL to the at least one content requesting entity at the publication time further comprises providing a time indicator associated with one of the expiration of content access time period and the second expiration of the supplemental access time period.

14. The method of providing access to electronic media content according to claim 13, wherein the time indicator further comprises an expiration time of at least one of the content access time period and the supplemental content access time period.

15. The method of providing access to electronic media content according to claim 13, wherein the time indicator further comprises a countdown timer of a remaining time to an expiration time of one of the content access time period and the supplemental content access time period.

16. The method of providing access to electronic media content according to claim 9, wherein providing the subscription query further comprises indicating at least one access requirement to be taken by the at least one content requesting entity configured to allow the at least one content requesting entity to access the content after one of the expiration of the content access time period and the second expiration of the supplemental content access period.

17. The method of providing access to electronic media content according to claim 9, wherein providing continued access to the content via the URL after the expiration of the content access time period until the second expiration of the supplemental content access time period further comprises providing supplemental electronic media content presented with the content during at least a portion of the supplemental content access time period.

18. A content access management system comprising:
a memory configured to store processor instructions configured to provide access to electronic media content for a content requesting entity;
a processor, in communication with the memory, configured to execute the processor instructions;
a storage device, in communication with the processor, configured to store and retrieve the electronic media content; and
a media server, in communication with the processor and the storage device, the media server being configured
to associate a content access time period with the electronic media content,
to provide a uniform resource locator (URL) to the content at a publication time,
to receive a content access request from at least one content requesting entity,
to determine a type of requesting entity of the at least one content requesting entity,
to provide access to the content via the URL, based on the determining of the type of requesting entity, to the at least one content requesting entity from the publication time until an expiration time of the content access time period, and
to provide a subscription query, based on reaching the expiration time of the content access time period, to the at least one content requesting entity.

19. The content management system according to claim 18, wherein the media server is further configured:
to append a supplemental content access time period to the expiration time of the content access time period; and
to provide continued access to the content via the URL after the expiration time of the content access time period to the at least one content requesting entity until a second expiration time of a supplemental content access time period.

20. The content management system according to claim 19, wherein providing continued access to the content via the URL after the expiration time of the content access time period until the second expiration time of the supplemental content access time period further comprises providing supplemental electronic media content presented with the content during at least a portion of the supplemental content access time period.
